(19) United States
(12) Patent Application Publication
(10) Pub. No.: US 2008/0106987 A1
(43) Pub. Date: May 8, 2008

(54) METHOD AND DEVICE FOR MEASURING ECCENTRICITY OF OPTICAL DISK

(75) Inventor: Yuan-Hung Chao, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/557,950

(22) Filed: Nov. 8, 2006

(51) Int. Cl. G11B 7/00

(52) U.S. Cl. 369/53.14

(57) ABSTRACT

A method for measuring an eccentricity of an optical disk is provided. The method includes steps of: rotating the optical disk with a spindle motor; irradiating a light beam emitted from an optical pickup on the optical disk; detecting the light beam reflected from the optical disk with a detector; generating tracking error signals; receiving electronic signals from the spindle motor; calculating a quantity of tracks traversed by the light beam during determined revolutions of the optical disk based on the tracking error signals and the electronic signals from the spindle motor; and determining the eccentricity of the optical disk based on the quantity of the tracks.

### BACKGROUND OF THE INVENTION

1. Field of the Invention

The present invention relates to methods and devices for measuring eccentricities and, more particularly, to a method for measuring an eccentricity of an optical disk and a device implementing the same.

2. Description of related art

To record or reproduce information on or from an optical disk, a light beam needs to be projected accurately on data tracks on the optical disk.

The optical disk is generally designed to have a symmetrical shape. However, practically, the optical disk may not be the ideal shape. Mechanical positional deviation and/or plastic deformation and etc. introduce an eccentricity of the optical disk. When the eccentricity is too great, tracking servo operations following up the track deviation fails to proceed. This leads to a problem that the light beam cannot be projected accurately on a desired track.

Therefore, a method for measuring an eccentricity of an optical disk and a device implementing the method are desired.

### SUMMARY OF THE INVENTION

In one aspect, a method for measuring an eccentricity of an optical disk is provided. The method includes steps of: rotating the optical disk with a spindle motor; irradiating a light beam emitted from an optical pickup on the optical disk; detecting the light beam reflected from the optical disk with a detector; generating tracking error signals; receiving electronic signals from the spindle motor; calculating a quantity of tracks traversed by the light beam during determined revolutions of the optical disk based on the tracking error signals and the electronic signals from the spindle motor; and determining the eccentricity of the optical disk based on the quantity of the tracks.

In another aspect, a method for measuring an eccentricity of an optical disk is provided. The method includes steps of: locating the optical disk onto a spindle motor; driving the spindle motor to rotate the optical disk; irradiating a light beam emitted from the optical pickup on the optical disk; detecting the light beam reflected from the optical disk and generating electronic signals in terms of the light beam with a detector; generating tracking error signals with a tracking servo circuit; outputting electronic signals from the spindle motor to a signal processing circuit; and determining in the signal processing circuit the eccentricity of the optical disk in accordance with a quantity of tracks traversed by the light beam during determined revolutions of the optical disk based on the tracking error signals and the electronic signals from the spindle motor.

In still another aspect, a device for measuring an eccentricity of an optical disk is provided. The device includes a spindle motor, an optical pickup, a detector, a tracking servo circuit, and a processor. The spindle motor locates the optical disk thereon and rotates the optical disk. The optical pickup emits a light beam to irradiate the optical disk. The detector receives the light beam reflected from the optical disk and generates electronic signals in terms of the light beam. The tracking servo circuit receives the electronic signals and produces tracking error signals in a sinusoidal waveform. The processor determines and outputs the eccentricity based on the tracking error signals. The processor has a shaping circuit configured for transforming the tracking signals from the sinusoidal waveform to a pulse waveform, a counter configured for receiving the tracking error signals in the pulse waveform, counting a quantity of tracks traversed by the light beam; and an operation circuit configured for calculating the eccentricity in accordance with the quantity of the tracks.

Other advantages and novel features will become more apparent from the following detailed description of preferred embodiments when taken in conjunction with the accompanying drawings, in which:

### BRIEF DESCRIPTION OF THE DRAWINGS

FIG. 1 is a block diagram of a device for measuring an eccentricity of an optical disk in accordance with an exemplary embodiment; and

FIG. 2 is a flow chart illustrating a method for measuring an eccentricity of the optical disk of FIG. 1.

### DETAILED DESCRIPTION OF THE INVENTION

Reference will now be made to the drawings to describe the exemplary embodiment of the device and the method, in detail.

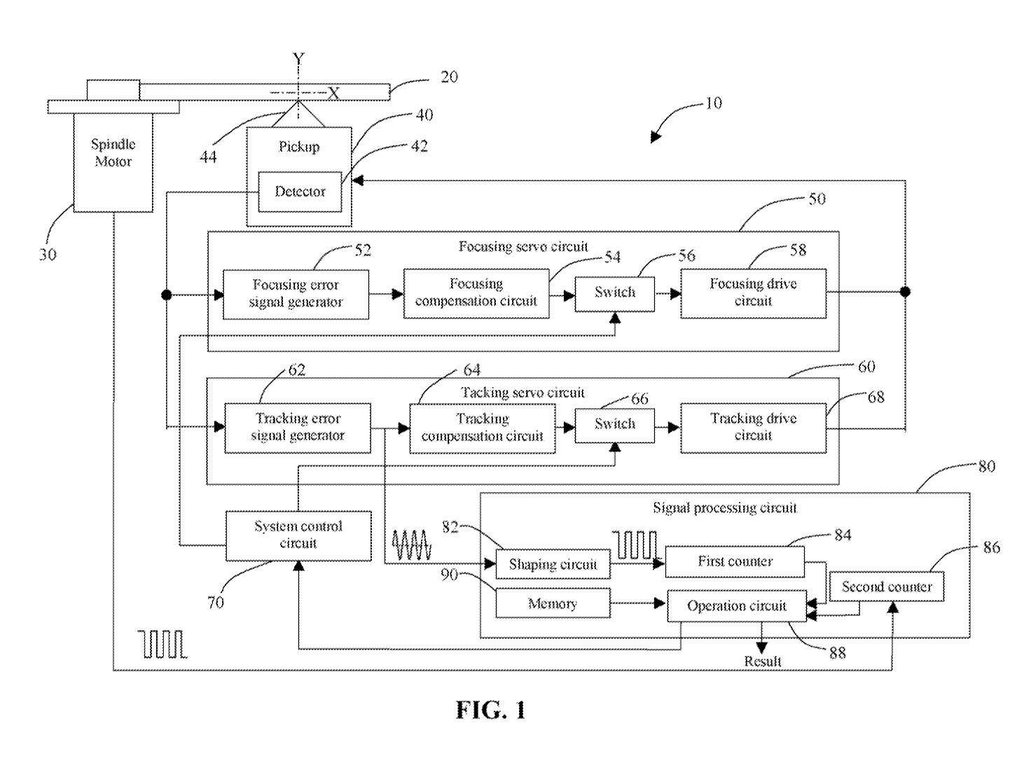

Referring to FIG. 1, a device 10 for measuring an eccentricity of an optical disk 20 in accordance with an exemplary embodiment is illustrated. The device 10 includes a spindle motor 30, an optical pickup 40, a focusing servo circuit 50, a tracking servo circuit 60, a system control circuit 70, and a signal processing circuit 80.

The spindle motor 30 is configured for supporting the optical disk 20 thereon and driving the optical disk 20 to rotate at a predetermined rotational speed.

The optical pickup 40 is electronically connected to and controlled by the focusing servo circuit 50 and the tracking servo circuit 60. The optical pickup 40 includes a detector 42, a light source (not shown), and a plurality of optical lenses (not shown) therein. The light source is capable of emitting a light beam 44. The optical lenses are capable of focusing the light beam 44 on the optical disk 20. The detector 42 may be a photo diode and configured for detecting the light beam 44 reflected from the optical disk 20 and outputting electronic signals based on the received light beam 44.

The focusing servo circuit 50 includes a focusing error signal generator 52, a focusing compensation circuit 54, a switch 56, and a focusing drive circuit 58. The focusing error signal generator 52 is electronically connected to the detector 42 for receiving the electronic signals and generating focusing error signals. The focusing compensation circuit 54 is electronically connected to the focusing error signal generator 52 for receiving the focusing error signals and outputting focusing compensation signals based on the focusing error signals. The focusing drive circuit 58 is electronically connected to the focusing compensation circuit 54 via the switch 56. The switch 56 is turned on/off in accordance with signals outputted from the system control circuit 70. If the switch 56 is turned on, the focusing drive circuit 58 is capable of receiving the focusing compensation signals from the focusing compensation circuit 54 and sending out focusing drive signals to adjust/move/drive the optical pickup 40, that is, a focusing servo operation for moving the light beam 44 along a direction Y perpendicular to the optical disk 20 is performed. If the switch 56 is turned off, the focusing compensation signals from the focusing compensation circuit 54 cannot be fed to the optical pickup 40 thus, the focusing servo operation is not performable.

The tracking servo circuit 60 includes a tracking error signal generator 62, a tracking compensation circuit 64, a switch 66 and a focusing drive circuit 68. The tracking error signal generator 62 is electronically connected to the detector 42 for receiving the electronic signals and generating tracking error signals. The tracking compensation circuit 64 is electronically connected to the tracking error signal generator 62 for receiving the tracking error signals and outputting tracking compensation signals. The tracking drive circuit 68 is electronically connected to the tracking compensation circuit 64 via the switch 66. The switch 66 is turned on/off in accordance with signals output from the system control circuit 70. If the switch 66 is turned on, the tracking drive circuit 68 is capable of receiving the tracking compensation signals and sending out tracking drive signals to adjust/move/drive the optical pickup 40, that is, a tracking servo operation for moving the light beam 44 along a direction X parallel to the optical disk 20 is performed. If the switch 66 is turned off, the signals from the tracking compensation circuit 64 cannot be applied to the optical pickup 40 so that the tracking servo operation is inactive.

The signal processing circuit 80 includes a shaping circuit 82, a first counter 84, a second counter 86, and an operation circuit 88. The shaping circuit 82 is electronically connected to the tracking error signal generator 62 for receiving the tracking error signals in a sinusoidal waveform and transforming the tracking error signals in the sinusoidal waveform to a rectangle waveform. The first counter 84 is electronically connected to the shaping circuit 82, and configured for counting a tracking error signal pulse count. The second counter 86 is electronically connected to the spindle motor 30 for receiving and counting an electronic signals pulse count of the electronic signals sent by the spindle motor 30. A quantity of tracks traversed by the light beam 44 is determinable by the first counter 84, and a number of revolutions that the spindle motor 30 rotates is determinable by the second counter 86. The operation circuit 88 is electronically connected to the counter 84 for calculating an eccentricity of the optical disk 20 based on the quantity of tracks traversed and the number of revolutions (e.g., the quantity of tracks traversed per revolution) and outputting a result signal to the system control circuit 70. The memory 90 is electronically connected to the operation circuit 88 and configured for storing a reference value. The eccentricity of the optical disk 20 can be compared with the reference value. The reference value can be changed in accordance with different precision requirements.

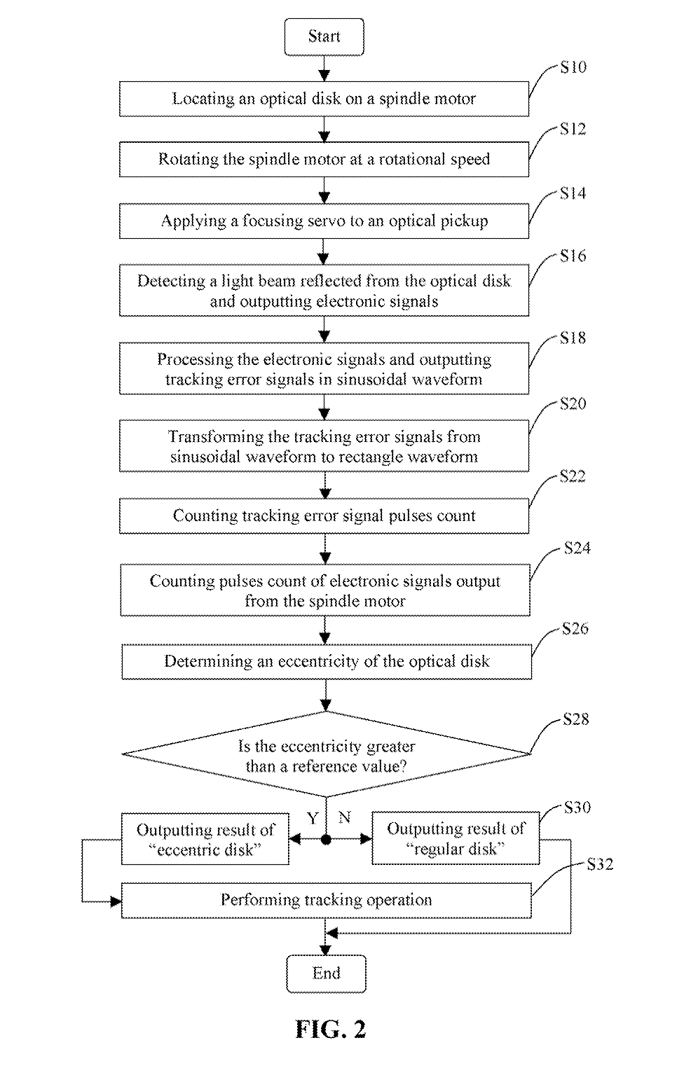

Referring also to FIG. 2, the device 10 can be operated as follows.

First, in step S10, the optical disk 20 is placed onto the spindle motor 30.

Second, in step S12, the optical disk 20 is rotated at a predetermined rotational speed by the spindle motor 30.

Third, in step S14, the system control circuit 70 signals the switch 56 to turn on and signals the switch 66 to turn off; thus, the focusing servo operation is activated and the tracking servo operation is inactivated.

Fourth, in step S16, the detector 42 detects the light beam 44 reflected from the optical disk 20, and outputs electronic signals transformed from light signals in the reflected light beam 44. The focusing error signal generator 52 receives the electronic signals from the detector 42 and outputs focusing error signals to the focusing compensation circuit 54. The focusing compensation circuit 54 outputs the tracking compensation signals to the focusing drive circuit 58 via the switch 56. The focusing drive circuit 58 adjusts the optical pickup 40. The light beam 44 emitted from the optical pickup 40 is thus projected on the optical disk 20.

Fifth, in step S18, the tracking error signal generator 62 processes the electronic signals from the detector 42 and outputs the tracking error signals in the sinusoidal waveform to the shaping circuit 82.

Sixth, in step S20, the shaping circuit 82 transforms the tracking error signals in the sinusoidal waveform to the rectangle waveform and outputs the tracking error signals in the rectangle waveform to the counter 84.

Seventh, in step S22, the first counter 84 counts the tracking error signals pulse count to determine the quantity of tracks traversed by the light beam 44, and outputs signals to the operation circuit 88.

Eighth, in step S24, the second counter 86 counts the electronic signals pulses count of the electronic signals from the spindle motor 30 to determine the quantity of revolutions the optical disk 20 rotates, and outputs signals to the operation circuit 88.

Ninth, in step S26, the operation circuit 88 calculates the eccentricity of the optical disk 20 based on the quantities of the tracks and the revolutions. The eccentricity of the optical disk 20 can be easily calculated. For example, the eccentricity approximately equals to the number of the tracks traversed by the light beam 44 in one revolution divided by a constant. The eccentricity can be also described by deviating distance of the tracks relative to a center of the optical disk 20 and can be easily calculated because widths of the adjacent tracks and track pitches are known from published specifications of the optical disk 20, and the number of the tracks traversed by the light beam 999 on the optical disk 20 in one revolution can be counted.

Tenth, in step S28, the operation circuit 88 compares the eccentricity of the optical disk 20 with a reference value stored in the memory 90 to analyze the eccentricity of the optical disk 20. If the eccentricity of the optical disk 20 is greater than the reference value, the optical disk 20 is identified as an eccentric disk (step 30), and the system control circuit 70 outputs a signal to turn on the switch 66 (step S32). The tracking drive circuit 68 can thus receive the tracking error correction signal and output electronic signals to adjust the optical pickup 40 to moving the light beam 999 to a correct track. If the eccentricity of the optical disk 20 is less than the reference value, the disk 20 is identified as a regular disk (step S30).

The eccentricity of the optical disk 20 can thus be simply measured and adverse effects due to the eccentricity can be greatly reduced.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A method for measuring an eccentricity of an optical disk, the method comprising steps of:
rotating the optical disk with a spindle motor;
irradiating a light beam emitted from an optical pickup on the optical disk;
detecting the light beam reflected from the optical disk with a detector;
generating tracking error signals;
receiving electronic signals from the spindle motor; and
determining the eccentricity of the optical disk based on quantities of tracks traversed by the light beam during determined revolutions of the optical disk based on the tracking error signals and the electronic signals from the spindle motor.

2. The method as claimed in claim 1, further comprising the step of applying a focusing servo operation to the optical pickup for moving the light beam along a direction perpendicular to the optical disk.

3. The method as claimed in claim 2, wherein a tracking servo operation for moving the light beam along a direction parallel to the optical disk is not applied to the optical pickup until the quantity of tracks is calculated.

4. The method as claimed in claim 3, further comprising the step of comparing the eccentricity with a reference value to determine whether the optical disk is eccentric.

5. The method as claimed in claim 4, wherein if the eccentricity of the optical disk is greater than the reference value, the optical disk is regarded as an eccentric disk, and a tracking servo operation to the optical pickup is performed.

6. A method for measuring an eccentricity of an optical disk, the method comprising steps of:
locating the optical disk onto a spindle motor;
driving the spindle motor to rotate the optical disk;
irradiating a light beam emitted from the optical pickup on the optical disk;
detecting the light beam reflected from the optical disk and generating electronic signals in terms of the light beam with a detector;
generating tracking error signals with a tracking servo circuit;
outputting electronic signals from the spindle motor to a signal processing circuit; and
determining in the signal processing circuit the eccentricity of the optical disk in accordance with a quantity of tracks traversed by the light beam during determined revolutions of the optical disk based on the tracking error signals and the electronic signals from the spindle motor.

7. The method as claimed in claim 6, wherein the electronic signals transformed by the detector are received by the tracking servo circuit.

8. The method as claimed in claim 7, further comprising the step of applying a focusing servo operation to the optical pickup with a focusing servo circuit for moving the light beam along a direction perpendicular to the optical disk.

9. The method as claimed in claim 8, wherein a tracking servo operation for moving the light beam along a direction parallel to the optical disk is not applied to the optical pickup by a focusing servo circuit before the quantity of the tracks is calculated.

10. The method as claimed in claim 6, further comprising the step of comparing the eccentricity with a reference value stored in a memory to determine whether the optical disk is eccentric.

11. The method as claimed in claim 10, wherein if the eccentricity of the optical disk is greater than the reference value stored in the memory, the optical disk is identified as an eccentric disk, and the tracking servo operation the optical pickup is performed.

12. The method as claimed in claim 10, further comprising the step of outputting the determined result from the signal processing circuit.

13. A device for measuring eccentricity of an optical disk comprising:
a spindle motor configured for locating the optical disk thereon and rotating the optical disk;
an optical pickup configured for emitting a light beam to the optical disk;
a detector configured for receiving the light beam reflected from the optical disk and generating electronic signals in terms of the light beam;
a tracking servo circuit configured for receiving the electronic signals from the detector and producing tracking error signals; and
a signal processing circuit configured for determining and outputting the eccentricity of the optical disk based on the tracking error signals in a sinusoidal waveform, the signal processing circuit having a shaping circuit configured for transforming the tracking error signals from the sinusoidal waveform to a rectangle waveform, a first counter configured for receiving the tracking error signals in the rectangle waveform and counting a quantity of tracks traversed by the light beam, a second counter configured for receiving electronic signals from the spindle motor and counting a quantity of revolutions of the optical disk; and an operation circuit configured for determining the eccentricity of the optical disk in accordance with the quantity of the tracks traversed by the light beam during the revolutions of the optical disk.

14. The device as claimed in claim 13, wherein the signal processing circuit further comprises a memory electronically connected to the operation circuit and configured for storing a reference value.

15. The device as claimed in claim 13, further comprises a system control circuit configured for receiving electronic signals output from the operation circuit, and determining whether the tracking servo signals need to be output to the optical pickup.

16. The device as claimed in claim 15, wherein the tracking servo circuit comprises a tracking error signal generator configured for receiving the electronic signals from the detector and generating tracking error signals, a tracking compensation circuit configured for receiving the tracking error signals and outputting tracking compensation signals, a tracking drive circuit configured for receiving the tracking compensation signals and sending out tracking drive signals to adjust the optical pickup, and a and the tracking drive circuit configured for receiving the tracking compensation signals and applying tracking servo operations to the optical pickup for moving the light beam along a direction parallel to the optical disk.

17. The device as claimed in claim 16, wherein the tracking servo circuit further comprising a first switch configured for receiving a signal transmitted from the system control circuit to control an electronic connection between the tracking compensation circuit and the tracking drive circuit.

18. The device as claimed in claim 13, further comprising a focusing servo circuit configured for receiving the electronic signals from the detector and applying focusing servo operations to the optical pickup for moving the light beam along a direction perpendicular to the optical disk.

19. The device as claimed in claim 18, the focusing servo circuit comprises a focusing error signal generator configured for receiving the electronic signals from the detector and generating focusing error signals, a focusing compensation circuit configured for receiving the focusing error signals and outputting focusing compensation signals, a focusing drive circuit configured for receiving the focusing compensation signals and sending out focusing drive signals to adjust the optical pickup, and a and the focusing drive circuit configured for receiving the focusing compensation signals and applying the focusing servo operations to the optical pickup.

20. The device as claimed in claim 19, wherein the focusing servo circuit further comprising a second switch configured for receiving a signal transmitted from the system control circuit to control an electronic connection between the focusing compensation circuit and the focusing drive circuit.
